(19) United States
(12) Patent Application Publication
(10) Pub. No.: US 2014/0238193 A1
(43) Pub. Date: Aug. 28, 2014

(54) TUBE WELDING ROD RESISTANT TO LOW STRESS ABRASION

(71) Applicants: Liehua Zhang, Wuhan (CN); Quansheng Song, Wuhan (CN)

(72) Inventors: Liehua Zhang, Wuhan (CN); Quansheng Song, Wuhan (CN)

(73) Assignee: KINGDREAM PUBLIC LIMITED COMPANY, Wuhan, Hubei (CN)

(21) Appl. No.: 14/351,995

(22) PCT Filed: Nov. 1, 2011
(86) PCT No.: PCT/CN2011/081649

§ 371 Date: Apr. 15, 2014

(51) Int. Cl. B23K 35/24; B23K 35/02

(52) U.S. Cl. CPC B23K 35/24; B23K 35/0261
USPC 75/302

(57) ABSTRACT

A tube welding rod resistant to low stress abrasion comprises a welded tube and a filler filling the welded tube. Components of the filler comprise macrocrystalline tungsten carbide particles, cast tungsten carbide particles and/or spherical cast tungsten carbide particles undergone surface carburization treatment, mechanically ground cast tungsten carbide particles, alloy powder, and an organic binder. The weight percentages of the components are: the macrocrystalline tungsten carbide particles being 10-50%, the cast tungsten carbide particles and/or spherical cast tungsten carbide particles undergone surface carburization treatment being 43-85%, the mechanically ground cast tungsten carbide particles being 0-20%, the alloy powder being 2-6%, and the organic binder being 0.2-1%. The welding rod improves the abrasion resistance performance of the hard-faced layer in the low stress working condition, and is particularly suitable for surface hardening of cone rolling bits and diamond bits.

### FIELD OF THE INVENTION

The present invention relates to a tube welding rod resistant to low stress abrasion, used as deposit-welding of wear-resistant layers. The tube welding rod is particularly suitable for use under working conditions of low stress abrasion, can be used for surface hardening of geological drilling cone rock bits and diamond bits, and also can be used for surface hardening of other iron and steel materials.

### BACKGROUND OF THE INVENTION

With advancement in geological exploration drilling technologies, the requirements for the performance of drilling tools used in oil drilling are higher and higher, and the working conditions the oil drilling bits deal with are increasingly complex and poor. Accordingly, the requirements for wear resistance of wear-resistant deposit-welding layers on the bits are increasingly higher and higher.

There are multiple areas on the bits that require improvement on wear resistance. In terms of working conditions and wear resistance of the bit, one the one hand, high wear resistance under low stress is required, which usually can be measured and evaluated based on ASTM G65 standard; on the other hand, high wear resistance under high stress is required, which usually can be measured and evaluated based on ASTM B611 standard. According to complexity of the working conditions of the bit, different parts of the bit can be applied with different deposit-welded welding rods that have different performance characteristics, such that the overall performance of the bit can be improved. For wear-resistant tube welding rods under low stress, a wear-resistant phase of the filler in the wear-resistant tube welding rods has undergone continuous improvement of mechanically crushed cast tungsten carbide particles, macro-crystalline tungsten carbide particles, and the combination of macro-crystalline tungsten carbide particles and mechanically crushed cast tungsten carbide. However, it is still an urgent need to further design optimized welding rod filler to enhance and perfect the wear resistance and welding property of the tube welding rod.

### SUMMARY OF THE INVENTION

In one aspect, the present invention is directed to a tube welding rod with high wear resistance that is resistant to low stress abrasion.

In one embodiment, the tube welding rod includes a welding tube and a filler filled in the welding tube. The filler includes macro-crystalline tungsten carbide particles, cast tungsten carbide particles undergoing surface carburization treatment and/or spherical cast tungsten carbide particles, mechanically crushed cast tungsten carbide particles, alloy powder, and an organic binder. The weight percentages of the components are as follows: 10%-50% of the macro-crystalline tungsten carbide particles, 43%-85% of the cast tungsten carbide particles undergoing surface carburization treatment and/or spherical cast tungsten carbide particles, 0%-20% of the mechanically crushed cast tungsten carbide particles, 2%-6% of the alloy powder, and 0.2%-1% of the organic binder.

In one embodiment, the macro-crystalline tungsten carbide particles are monocrystalline tungsten carbide particles and/or polycrystalline tungsten carbide particles, and the particle size thereof is 20-200 mesh by the U.S. Standard Sieve Series mesh sizes.

In one embodiment, the particle size of the cast tungsten carbide particles undergoing surface carburization treatment is 40-200 mesh by the U.S. Standard Sieve Series mesh sizes. The main chemical compositions the cast tungsten carbide particles undergoing surface carburization treatment, by weight percentage, greater than or equal to 95.00% of tungsten, and 3.85-4.15% of carbon.

In one embodiment, the particle size of the spherical cast tungsten carbide particles is 40-200 mesh by the U.S. Standard Sieve Series mesh sizes. The main chemical compositions of the spherical cast tungsten carbide particles, by weight percentage, greater than or equal to 95.00% of tungsten, 3.85%-4.0% of carbon, 0.15-0.50 of iron, 0.10-0.20 of chromium, and 0.10-0.20 of vanadium.

In one embodiment, the alloy powder includes iron, silicon, manganese, niobium, and nickel, and the weight percentages of the components are: 12%-20% of iron, 10%-16% of silicon, 45%-53% of manganese, 5%-15% of niobium, and 5%-15% of nickel.

In one embodiment, the weight percentage of the cast tungsten carbide particles undergoing surface carburization treatment in the filler is 15%-80%, and the weight percentage of the spherical cast tungsten carbide particles in the filler is 5%-70%.

In one embodiment, the weight percentages of the welding tube and the filler are 20%-40% and 60%-80%, respectively.

In one embodiment, the welding tube is formed by rolling of low carbon steel sheet, and carbon content of the low carbon steel is less than or equal to 0.20% by weight.

In one embodiment, the organic binder is phenolic resin.

Certain embodiments of the present invention, among other things, have the following beneficial advantages.

1. Cast tungsten carbide undergoing surface carburization treatment is used in the filler, which improves the welding property and wear resistance of the welding rod. In comparison with the mechanically crushed cast tungsten carbide, the surface layer of the cast tungsten carbide undergoing surface carburization treatment is a tungsten carbide layer. Tungsten carbide has better toughness than cast tungsten carbide and has higher bonding strength with bonding metal. Although the tungsten carbide and the cast tungsten carbide have no difference in the geometric shape, the welding property of the cast tungsten carbide undergoing surface carburization treatment is better, and the bonding strength of the surface to the bonding metal of the deposit-welding layer is higher, so that bearing capacity and impact resistance of the deposit-welding layer are further improved, and wear resistance thereof is improved correspondingly.

2. The spherical cast tungsten carbide in the filler improves hardness and wear resistance of the welding layer. For the spherical cast tungsten carbide, in comparison with the mechanically crushed cast tungsten carbide, firstly, due to differences in the geometric shapes, bearing capacity and impact resistance is greatly improved; secondly, the hardness of the spherical cast tungsten carbide is higher, the hardness of the mechanically crushed cast tungsten carbide usually is HV2200-2500, while the hardness of the spherical cast tungsten carbide is HV2600-3600, and thus the spherical cast tungsten carbide has higher wear resistance than the mechanically crushed cast tungsten carbide.

3. The composition of the alloy powder in the filler is adjusted. Optimal combination of iron, silicon, manganese, niobium, and nickel ensures that the tube welding rod resistant to low stress abrasion according to the present invention has better welding property during welding. In addition, selection of particle sizes of the macro-crystalline tungsten carbide particles, the cast tungsten carbide particles undergoing surface carburization treatment, and the spherical cast tungsten carbide particles is beneficial for the grading match between the multiple types of particles and for the optimal particle combination, and increases wear resistance of the deposit-welding layer.

4. The present invention not only ensures the welding property of the tube welding rod, but also improves the wear resistance of the deposit-welding layer of the tube welding rod under various working conditions. Macro-crystalline tungsten carbide particles and cast tungsten carbide particles undergoing surface carburization treatment and/or spherical cast tungsten carbide particles are used in the filler as a wear-resistant phase, which particularly improves the wear resistance of the deposit-welding layer of the tube welding rod in low stress conditions. Thus, the tube welding rod is suitable for surface hardening of cone rock bits and diamond bits, and also can be used for surface hardening of other iron and steel materials.

5. The mechanically crushed cast tungsten carbide particles are used to partially replace the cast tungsten carbide particles undergoing surface carburization treatment or spherical cast tungsten carbide particles, and the amount of the mechanically crushed cast tungsten carbide does not exceed the total amount of the cast tungsten carbide particles undergoing surface carburization treatment and the spherical cast tungsten carbide particles, which will reduce the wear resistance of the welding rod, but can decrease the manufacturing cost of the welding rod.

Several tube welding rods are designed and produced according to certain embodiments of the present invention. The welding property of the tube welding rods is evaluated, and the wear resistance of the deposit-welding layer is measured and evaluated based on ASTM G65 and ASTM B611 standard. Those properties are also compared with the properties of existing tube welding rods with advanced performance, and the results are as follows.

A reference welding rod in the related art: welding property, qualified; ASTM G65 wear quantity 0.0.3567 gram (g); ASTM B611 wear quantity, 0.7462 g. A welding rod according to a first embodiment of the present invention: welding property, qualified; ASTM G65 wear quantity, 0.2713 g; ASTM B611 wear quantity, 0.6710 g. Comparing with the reference welding rod, the welding rod in the first embodiment has a 31.5% increase in ASTM G65 wear resistance, and a 11.2% increase in ASTM B611 wear resistance.

A welding rod according to a second embodiment of the present invention: welding property, qualified; ASTM G65 wear quantity, 0.2500 g; ASTM B611 wear quantity 0.6438 g. Comparing with the reference welding rod, the welding rod in the second embodiment has a 42.7% increase in ASTM G65 wear resistance, and a 15.9% increase in ASTM B611 wear resistance.

A welding rod according to a third embodiment of the present invention: welding property, qualified; ASTM G65 wear quantity, 0.2941 g; ASTM B611 wear quantity 0.6852 g. Comparing with the reference welding rod, the welding rod in the third embodiment has a 21.3% increase in ASTM G65 wear resistance, and a 8.93% increase in ASTM B611 wear resistance.

A welding rod according to a fourth embodiment of the present invention: welding property, qualified; ASTM G65 wear quantity, 0.2609 g; ASTM B611 wear quantity 0.6639 g. Comparing with the reference welding rod, the welding rod in the fourth embodiment has a 36.7% increase in ASTM G65 wear resistance, and a 12.4% increase in ASTM B611 wear resistance.

### BRIEF DESCRIPTION OF THE DRAWINGS

FIG. 1 is a photomicrograph of a deposit-welding layer of a tube welding rod according to one embodiment of the present invention. In FIG. 1, the irregular bright part denotes a macro-crystalline tungsten carbide particle, the irregular black part with bright ring around it denotes a cast tungsten carbide particle undergoing surface carburization treatment, and the black round part denotes a spherical cast tungsten carbide particle.

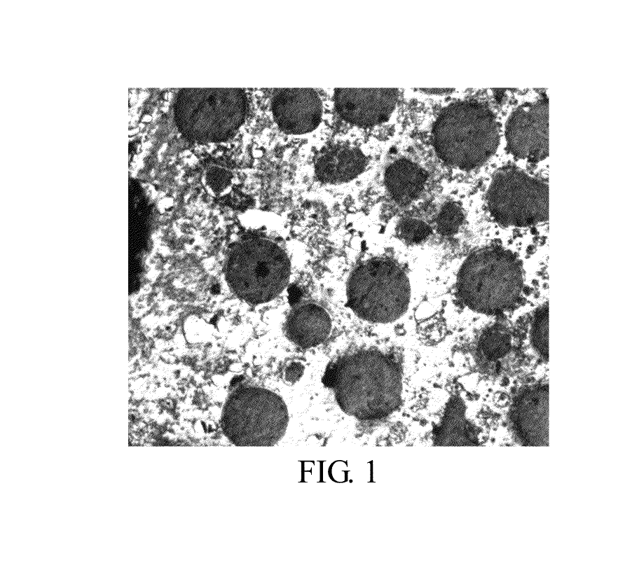

### DETAILED DESCRIPTION OF THE INVENTION

### Embodiment 1

A tube welding rod is designed and manufactured according to one embodiment of the present invention. A filler of the tube welding rod, by weight percentage, is composed of 15% of macro-crystalline tungsten carbide particles, 65% of cast tungsten carbide particles undergoing surface carburization treatment, 15% of spherical cast tungsten carbide particles, 4% of alloy powder, and 1% of organic binder. The particle size of the macro-crystalline tungsten carbide particles is 60-100 mesh, the particle size of the cast tungsten carbide particles undergoing surface carburization treatment is 80-140 mesh, and the particle size of the spherical cast tungsten carbide particles is 80-200 mesh. The particle sizes are determined according to a U.S. standard Sieve Series mesh sizes. The alloy powder is composed of 18% of iron, 12% of silicon, 48% of manganese, 11% of niobium, and 11% of nickel by weight. The weight percentage of the filler in the tube welding rod is 65%. The welding tube is formed by rolling of low carbon steel sheet, and carbon content of the low carbon steel is 0.05%-0.11% by weight.

Experimental results show that, compared with the related advanced products in the world, the wear resistance of the deposit-welding layer under low stress measured with the ASTM G65 standard is improved by 30%, the wear resistance of the deposit- welding layer under high stress measured with the ASTM B611 standard is improved by more than 10%. Thus, the tube welding rod according to this embodiment of the present invention shows obvious advantages over similar type of product in the industry.

### Embodiment 2

A tube welding rod is designed and manufactured according to one embodiment of the present invention. A filler in a welding tube of the tube welding rod, by weight percentage, is composed of 15% of macro-crystalline tungsten carbide particles, 15% of cast tungsten carbide particles undergoing surface carburization treatment, 64% of spherical cast tungsten carbide particles, 5% of alloy powder, and 1% of organic binder. The particle size of the macro-crystalline tungsten carbide particles is 20-100 mesh, the particle size of the cast tungsten carbide particles undergoing surface carburization treatment is 40-100 mesh, and the particle size of the spherical cast tungsten carbide particles is 80-200 mesh. The particle sizes are determined according to a U.S. Standard Sieve Series mesh sizes. The alloy powder is composed of 15% iron, 15% silicon, 50% manganese, 10% niobium, and 10% nickel by weight. The weight percentage of the filler in the tube welding rod is 73%. The welding tube is formed by rolling of low carbon steel sheet, and carbon content of the low carbon steel is 0.05%-0.11% by weight. Experimental results show that, compared with the related advanced products in the world, the wear resistance of the deposit-welding layer under low stress measured with the ASTM G65 standard is improved by 40%, the wear resistance of the welding layer under high stress measured with the ASTM B611 standard is improved by more than 15%. Thus, the tube welding rod according to this embodiment of the present invention shows obvious advantages over similar type of product in the industry.

### Embodiment 3

A tube welding rod is designed and manufactured according to one embodiment of the present invention. A filler of the tube welding rod is composed of 45% of macro-crystalline tungsten carbide particles, 25% of cast tungsten carbide particles undergoing surface carburization treatment, 5% of spherical cast tungsten carbide particles, 20% of mechanically crushed cast tungsten carbide particles, 4% of alloy powder, and 1% of organic binder by weight. The particle size of the macro-crystalline tungsten carbide particles is 60-140 mesh, the particle size of the cast tungsten carbide particles undergoing surface carburization treatment is 80-200 mesh, the particle size of the spherical cast tungsten carbide particles is 40-100 mesh, and the particle size of the mechanically crushed cast tungsten carbide particles is 40-100 mesh. The particle sizes are determined according to U.S. Standard Sieve Series mesh sizes. The alloy powder is composed of 18% iron, 12% of silicon, 48% of manganese, 11% of niobium, and 11% of nickel by weight. The weight percentage of the filler in the tube welding rod is 68%. The welding tube is formed by rolling of low carbon steel sheet, and carbon content of the low carbon steel is 0.05%-0.11% by weight percentage. Experimental results show that, compared with the related advanced products in the world, the wear resistance of the deposit-welding layer under low stress measured with the ASTM G65 standard is improved by 20%, the wear resistance of the welding layer under high stress measured with the ASTM B611 standard is improved by more than 8%. Thus, the tube welding rod according to this embodiment of the present invention shows obvious advantages over similar type of product in the industry.

### Embodiment 4

A tube welding rod is designed and manufactured according to one embodiment of the present invention. A filler of the tube welding rod is composed of 40% of macro-crystalline tungsten carbide particles, 15% of cast tungsten carbide particles undergoing surface carburization treatment, 25% of spherical cast tungsten carbide particles, 15% of mechanically crushed cast tungsten carbide particles, 4% of alloy powder, and 1% of organic binder by weight. The particle size of the macro-crystalline tungsten carbide particles is 60-140 mesh, the particle size of the cast tungsten carbide particles undergoing surface carburization treatment is 80-200 mesh, the particle size of the spherical cast tungsten carbide particles is 60-140 mesh, and the particle size of the mechanically crushed cast tungsten carbide particles is 80-200 mesh. The particle sizes are determined according to U.S. Standard Sieve Series mesh sizes. The alloy powder is composed of 18% of iron, 12% of silicon, 48% of manganese, 11% of niobium, and 11% of nickel by weight. The weight percentage of the filler in the tube welding rod is 70%. The welding tube is formed by rolling of low carbon steel sheet, and carbon content of the low carbon steel is 0.05%-0.11% by weight percentage. Experimental results show that, compared with related advanced products in the world, the wear resistance under low stress measured with the ASTM G65 standard is improved by 35%, the wear resistance under high stress measured with the ASTM B611 standard is improved by more than 10%. Thus, the tube welding rod according to this embodiment of the present invention shows obvious advantages over similar type of product in the industry.

What is claimed is:

1. A tube welding rod resistant to low stress abrasion, comprising
a welding tube; and
a filler filled in the welding tube, comprising 10%-50% of macro-crystalline tungsten carbide particles are, 43%-85% of cast tungsten carbide particles undergoing surface carburization treatment and/or spherical cast tungsten carbide particles, 0%-20% of mechanically crushed cast tungsten carbide particles, 2%-6% of alloy powder, and 0.2%-1% of an organic binder by weight.

2. The tube welding rod of claim 1, wherein the macro-crystalline tungsten carbide particles are monocrystalline tungsten carbide particles and/or polycrystalline tungsten carbide particles, and particle sizes thereof are 20-200 mesh based on U.S. Standard Sieve Series mesh sizes.

3. The tube welding rod of claim 1, wherein particle sizes of the cast tungsten carbide particles undergoing surface carburization treatment are 40-200 mesh based on U.S. Standard Sieve Series mesh sizes.

4. The tube welding rod of claim 3, wherein the cast tungsten carbide particles undergoing surface carburization treatment substantially comprises greater than or equal to 95.00% of tungsten and 3.85%-4.15% of carbon by weight.

5. The tube welding rod of claim 1, wherein particle sizes of the spherical cast tungsten carbide particles are 40-200 mesh based on U.S. Standard Sieve Series mesh sizes.

6. The tube welding rod of claim 5, wherein the spherical cast tungsten carbide particles substantially comprises greater than or equal to 95.00% of tungsten, 3.85%-4.0% of carbon, 0.15-0.50% of iron, 0.10-0.20% of chromium, and 0.10-0.20% vanadium by weight.

7. The tube welding rod of claim 1, wherein the alloy powder comprises 12%-20% of iron, 10%-16% of silicon, 45%-53% of manganese, 5%-15% of niobium, and 5%-15% of nickel.

8. The tube welding rod of claim 1, wherein the cast tungsten carbide particles undergoing surface carburization treatment in the filler is 15%-80% by weight, and the spherical cast tungsten carbide particles in the filler is 5%-70% by weight.

9. The tube welding rod of claim 1, wherein weight percentages of the welding tube and the filler are 20%-40% and 60%-80%, respectively.

10. The tube welding rod of claim 1, wherein the welding tube is formed by rolling of low carbon steel sheet, and carbon content of the low carbon steel is less than or equal to 0.20% by weight.
